(19) United States
(12) Patent Application Publication
(10) Pub. No.: US 2023/0077537 A1
(43) Pub. Date: Mar. 16, 2023

(54) ULTRASONIC LINEAR MOTOR

(71) Applicant: LG INNOTEK CO., LTD, Seoul (KR)

(72) Inventors: Sang Young LEE, Seoul (KR); Kab Young KIM, Seoul (KR); Yong Jae CHOI, Seoul (KR)

(21) Appl. No.: 17/798,120

(22) PCT Filed: Jun. 9, 2020
(86) PCT No.: PCT/KR2020/007423

§ 371 Date: Aug. 8, 2022

(30) Foreign Application Priority Data
Feb. 24, 2020 (KR) 10-2020-0022333

(51) Int. Cl. H02N 2/02; H02N 2/04

(52) U.S. Cl. CPC H02N 2/026; H02N 2/04

(57) ABSTRACT

An ultrasonic linear motor according to one embodiment is disclosed. The vibrating body includes an elastic body and a first piezoelectric element and a second piezoelectric element which are attached to two surfaces of the elastic body, a first weight and a second weight which are disposed on two side end portions of the vibrating body, a moving shaft which is coupled to a central portion of the vibrating body and moves according to a displacement of each of the piezoelectric elements, and a moving body which is fitted to the moving shaft and moves on the moving shaft.

### TECHNICAL FIELD

The present invention relates to an ultrasonic linear motor in which weights are disposed on two side end portions of a vibrating body.

### BACKGROUND ART

An ultrasonic motor has various advantages that, since the ultrasonic motor generates a high torque at a relatively low speed when compared to conventional electronic motors that are widely used, a speed reducer is not required, a generated mechanical output per unit weight is high, starting and stopping is quick, and the ultrasonic motor can be compact and lightweight, and since the ultrasonic motor is independent of a magnetic field, there is no problem such as electromagnetic induction, and a speed is constant when the ultrasonic motor is used, and the like. Accordingly, ultrasonic motors are being used in various fields.

Recently, as competition for camera zoom magnification of a mobile device is accelerated, research on various concepts of ultrasonic motors, such as rotational ultrasonic motors and linear ultrasonic motors, is being actively conducted to be applied to cameras.

FIG. 1 is a view illustrating an ultrasonic linear motor according to a conventional technology.

Referring to FIG. 1, in the ultrasonic linear motor according to the conventional technology, piezoelectric elements 120 are attached to an upper portion and a lower portion of an elastic body 110, a moving shaft 200 is perpendicularly attached to the piezoelectric element 120 attached to the upper portion, and a moving body 300 is coupled to the moving shaft 200 and moves on the moving shaft.

Such inertial-based ultrasonic motors have problems that a speed is low compared to friction-based ultrasonic motors, a resonance frequency per the same volume of piezoelectric element having a circular shape is relatively high, a resonance displacement is lowered, and a load of a driver integrated circuit (IC) is increased.

### RELATED ART

(Patent Document 1) Korean Registered Patent Publication No. 10-0768890
(Patent Document 2) Korean Registered Patent Publication No. 10-0683933

### Technical Problem

The present invention is directed to providing an ultrasonic linear motor in which weights are disposed on two side end portions of a vibrating body.

### Technical Solution

One aspect of the present invention provides an ultrasonic linear motor including a vibrating body including an elastic body and a first piezoelectric element and a second piezoelectric element which are attached to two surfaces of the elastic body, a first weight and a second weight which are disposed on two side end portions of the vibrating body, a moving shaft which is coupled to a central portion of the vibrating body and moves according to a displacement of each of the piezoelectric elements, and a moving body which is fitted to the moving shaft and moves on the moving shaft.

The first weight may be disposed on one upper end portion of the first piezoelectric element, and the second weight may be disposed on the other upper end portion of the first piezoelectric element.

The first weight may be disposed on one lower end portion of the second piezoelectric element, and the second weight may be disposed on the other lower end portion of the second piezoelectric element.

The first weight may be disposed on one side surface portion of the vibrating body, and the second weight may be disposed on the other side surface portion the vibrating body.

The first weight may be disposed on each of two side surface portions of the first piezoelectric element, and the second weight may be disposed on each of two side surface portions of the second piezoelectric element.

The first piezoelectric element and the first weight may be disposed on one surface of the elastic body, and the second piezoelectric element and the second weight may be disposed on the other surface of the elastic body.

The ultrasonic linear motor may further include connection members through which electric signals are applied to the elastic body, the first piezoelectric element, and the second piezoelectric element, wherein the connection members may include a first connection member connected to one side of the elastic body, a second connection member connected to one side of the first piezoelectric element, and a third connection member connected to one side of the second piezoelectric element.

The second connection member may be disposed between the first weight and the first piezoelectric element or disposed between the second weight and the first piezoelectric element.

The third connection member may be disposed on a lower portion of the second piezoelectric element corresponding to the second weight or disposed on a lower portion of the first piezoelectric element corresponding to the first weight.

A length of each of the first piezoelectric element and the second piezoelectric element may be two or more times a width thereof, a thickness of each of the first piezoelectric element and the second piezoelectric element may be 1/10 or less of the length, and a thickness of the elastic body may be 1 to 1.5 times the thickness of the first piezoelectric element or the second piezoelectric element.

A length of the weight may be ⅕ or less of a length of the first piezoelectric element or the second piezoelectric element, a thickness of the weight may be less than 1 mm, and a material of the weight may be stainless.

A diameter of the moving shaft may be in the range of ⅓ to ⅗ of a width of the first piezoelectric element or the second piezoelectric element, and a length of the moving shaft may be 2.5 to 3.5 times a length of the elastic body.

### Advantageous Effects

According to embodiments, since a vibrating body is formed in a quadrangular shape, an ultrasonic linear motor can be spatially optimized compared to a convention vibrating body formed in a circular shape.

According to the embodiments, since weights are disposed on two side end portions of the vibrating body, an inertial force can be increased due to the added weights, and thus a movement speed can be increased.

### DESCRIPTION OF DRAWINGS

FIG. 1 is a view illustrating an ultrasonic linear motor according to a conventional technology.

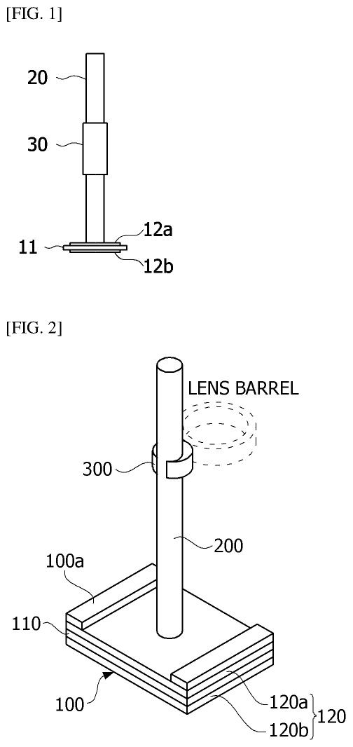

FIG. 2 is a view illustrating an ultrasonic linear motor according to one embodiment of the present invention.

FIG. 3 is a view illustrating a cross section of a moving shaft illustrated in FIG. 2.

FIGS. 4A and 4B are views illustrating a first structure of a vibrating body on which weights illustrated in FIG. 2 are disposed.

FIGS. 5A and 5B are views illustrating a second structure of a vibrating body on which weights illustrated in FIG. 2 are disposed.

FIGS. 6A and 6B are views illustrating a third structure of a vibrating body on which weights illustrated in FIG. 2 are disposed.

FIGS. 7A and 7B are views illustrating a fourth structure of a vibrating body on which weights illustrated in FIG. 2 are disposed.

FIGS. 8A to 8C and views for describing forms in which connection members are disposed on a vibrating body.

FIGS. 9A to 9D are graphs showing performance comparison results of an ultrasonic linear motor.

FIG. 10 is a view for describing an installation state of the ultrasonic linear motor according to an embodiment.

### MODES OF THE INVENTION

Hereinafter, exemplary embodiments of the present invention will be described in detail with reference to the accompanying drawings.

However, the technical spirit of the present invention is not limited to some embodiments which will be described and may be embodied in a variety of different forms, and at least one or more components of the embodiments may be selectively combined, substituted, and used in the range of the technical spirit.

In addition, unless clearly and specifically defined otherwise by the context, all terms (including technical and scientific terms) used herein can be interpreted as having meanings customarily understood by those skilled in the art, and meanings of generally used terms, such as those defined in commonly used dictionaries, will be interpreted in consideration of contextual meanings of the related art.

In addition, the terms used in the embodiments of the present invention are considered in a descriptive sense only and not to limit the present invention.

In the present specification, unless clearly indicated otherwise by the context, singular forms include the plural forms thereof, and in a case in which “at least one (or one or more) among A, B, and C” is described, this may include at least one combination among all possible combinations of A, B, and C.

In addition, in descriptions of components of the present invention, terms such as “first,” “second,” “A,” “B,” “(a),” and “(b)” can be used.

The terms are only to distinguish one element from another element, and the essence, order, and the like of the elements are not limited by the terms.

In addition, it should be understood that, when an element is referred to as being “connected” or “coupled” to another element, such a description may include both a case in which the element is directly connected or coupled to another element, and a case in which the element is connected or coupled to another element with still another element disposed therebetween.

In addition, when any one element is described as being formed or disposed “on” or “under” another element, such a description includes both a case in which the two elements are formed or disposed in direct contact with each other and a case in which one or more other elements are interposed between the two elements. In addition, when one element is described as being formed “on or under” another element, such a description may include a case in which the one element is formed at an upper side or a lower side with respect to another element.

In the embodiment, a new structure, in which a vibrating body is formed in a quadrangular shape, a moving shaft is coupled to a central portion of the vibrating body, and weights are disposed on two side end portions of the vibrating body, is proposed.

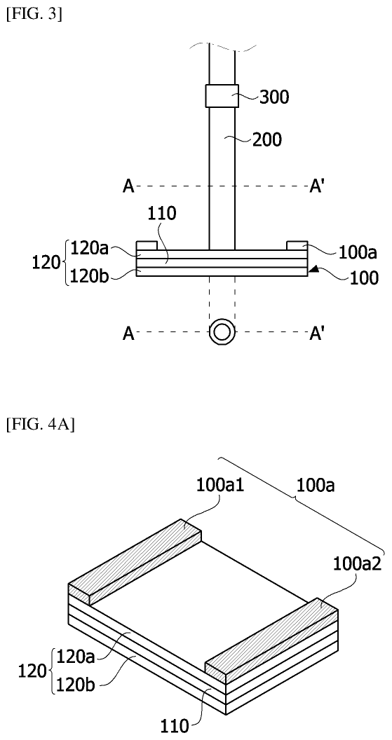

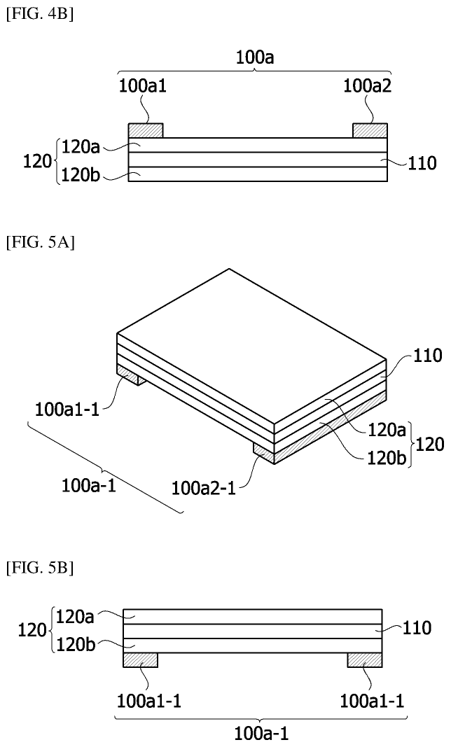

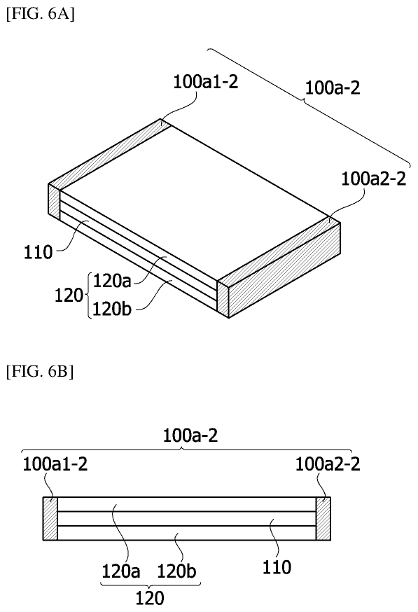

FIG. 2 is a view illustrating an ultrasonic linear motor according to one embodiment of the present invention, FIG. 3 is a view illustrating a cross section of a moving shaft illustrated in FIG. 2, and FIGS. 4A and 4B are views illustrating a first structure of a vibrating body on which weights illustrated in FIG. 2 are disposed.

Referring to FIGS. 2 to 4B, the ultrasonic linear motor according to the embodiment may be formed as a structure in which weights 100a are disposed on two side end portions of a vibrating body 100 including an elastic body 110 and piezoelectric elements 120.

The piezoelectric elements 120 may be attached to two surfaces of the elastic body 110. The present invention is not limited to a case in which the piezoelectric elements are attached to the two surfaces of the elastic body 110, and the piezoelectric element may be attached to one surface of the elastic body 110.

Aluminum (Al), brass, and stainless may be used as a material of the elastic body 110. In this case, a concept of the stainless may be a concept encompassing stainless steel (SS), steel type stainless (STS), and stainless use steel (SUS).

The piezoelectric elements 120 may include a first piezoelectric element 120a attached to one surface of the elastic body 110 and a second piezoelectric element 120b attached to the other surface of the elastic body 110.

The elastic body 110 and the piezoelectric elements 120 may be attached and coupled to each other using a conductive epoxy. In this case, an attachment thickness of the conductive epoxy may be in the range of 2 μm to 20 μm.

Electrodes may be sintered and formed on two surfaces of the piezoelectric elements 120. In this case, the electrodes may be Ag electrodes but are not necessarily limited thereto. A thickness of each of the electrodes may be 2.5 μm or less, and a tolerance between the piezoelectric ceramic and the electrode may be in the range of 50 μm to 200 μm.

A length of the piezoelectric element 120 in a first axial direction may be designed to be greater than a width of the piezoelectric element 120 in a second axial direction perpendicular to the first axial direction. In this case, the first axial direction may be an X-axial direction, and the second axial direction may be a Y-axial direction. Alternatively, the first axial direction may be a Y-axial direction, and the second axial direction may be an X-axial direction. The length of the piezoelectric element 120 may be two or more times the width. For example, the length may be in the range of 4 to 5 mm, and the width may be in the range of 2 to 2.5 mm.

A thickness of the piezoelectric element 120 may be designed to be smaller than the length of the piezoelectric element 120. The thickness of the piezoelectric element 120 may be 1/10 or less of the length. For example, the length may be in the range of 4 to 5 mm, and the thickness may be in the range of 0.1 to 0.5 mm.

A thickness of one piezoelectric element 120 may be designed to be smaller than a thickness of the elastic body 110, and a total thickness of the two piezoelectric elements 120 may be designed to be greater than the thickness of the elastic body 110. The thickness of the elastic body 110 may be 1 to 1.5 times the thickness of the piezoelectric element 120. For example, the thickness of the piezoelectric element may be in the range of 0.1 to 0.5 mm, and the thickness of the elastic body 110 may be in the range of 0.1 to 0.75 mm.

The moving shaft 200 may be attached and coupled to an upper portion of the piezoelectric element 120 using an adhesive resin. A length of the moving shaft 200 may be designed to be 2.5 to 3.5 times a length of the elastic body 110.

A diameter of the moving shaft 200 may be designed to be smaller than the width of the piezoelectric element 120. The diameter of the moving shaft 200 may be in the range of ⅓ to ⅗ of the width of the piezoelectric element 120. For example, the width of the piezoelectric element 120 may be in the range of 2 to 2.5 mm, and the diameter of the moving shaft 200 may be in the range of 0.7 to 1.5 mm.

The moving body 300 is friction-fitted to the moving shaft 200 and may move on the moving shaft 200, that is, move forward or rearward, by a frictional force generated due to a linear movement of the moving shaft 200. In this case, there may be a mechanical coupling member connecting the moving body 300 and the moving shaft 200, and the mechanical coupling member may allow the moving body to maintain a physical pressure on the moving shaft.

Referring to FIG. 3, a through hole having an outer diameter and an inner diameter may be formed in a central portion of the moving shaft 200 according to the embodiment. The size of the inner diameter may be in the range of 25% to 40% of a size of the outer diameter. Here, one example of a case in which the moving shaft has the inner diameter is described, but the present invention is not necessarily limited thereto.

The weights 100a may be disposed on the two side end portions of the vibrating body 100. Stainless, brass, or tungsten (W) may be used as a material of the weight 100a. Preferably, the stainless may be used as the material of the weight 100a.

Referring to FIGS. 4A to 4B, the weights 100a according to the embodiment may include a first weight 100a1 and a second weight 100a2, and the first weight 100a1 and the second weight 100a2 may be disposed on two side end portions of an upper portion of the first piezoelectric element 120a forming the vibrating body 100.

The first weight 100a1 and the second weight 100a2 may have the same size and weight. The reason why the first weight 100a1 and the second weight 100a2 have the same size and weight is that characteristics may change when sizes and weights thereof are different.

The performance improvement can be expected by changing an exterior of the piezoelectric element, that is, changing the exterior from the conventional circular shape to the quadrangular shape. Simulation results are in [Table 1] below.

TABLE 1

| Input | | Circular | | Quadrangular | | Quadrangular | |
|---|---|---|---|---|---|---|---|
| voltage | | piezoelectric | | piezoelectric | | piezoelectric | |
| [VPP] | | element | | element | | element, Add weight | |
| 3 | V | 2 | mm/s | 3.8 | mm/s | 5.3 | mm/s |
| 12 | V | 7.7 | mm/s | 15.6 | mm/s | 21.6 | mm/s |

As in Table 1, it shows that a displacement is greatly increased by changing the exterior of the piezoelectric element and adding the weight. Due to the increase in the displacement, a movement speed can be improved. Accordingly, when compared to the conventional voice coil motor (VCM), a disadvantage of a lower movement speed can be solved. Examples of movement speeds at a voltage of 3 V and a voltage of 12V are shown. It shows that, even at the voltage of 3 V which is a relatively low voltage, the movement speed is improved, and thus low voltage driving is possible by changing the exterior and adding the weight.

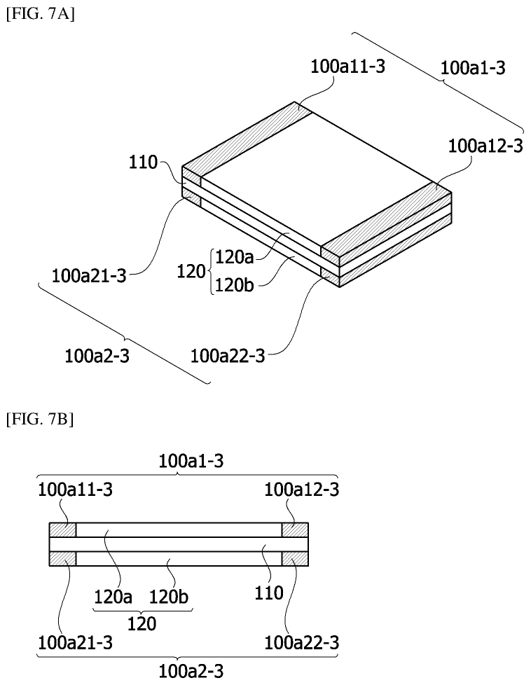

FIGS. 5A and 5B are views illustrating a second structure of a vibrating body on which weights illustrated in FIG. 2 are disposed. Referring to FIGS. 5A and 5B, weights 100a-1 according to an embodiment may include a first weight 100a1-1 and a second weight 100a2-1, and the first weight 100a1-1 and the second weight 100a2-1 may be disposed on two side end portions of a lower portion of a second piezoelectric element 120b forming a vibrating body 100.

The first weight 100a1-1 and the second weight 100a2-1 may have the same size and weight.

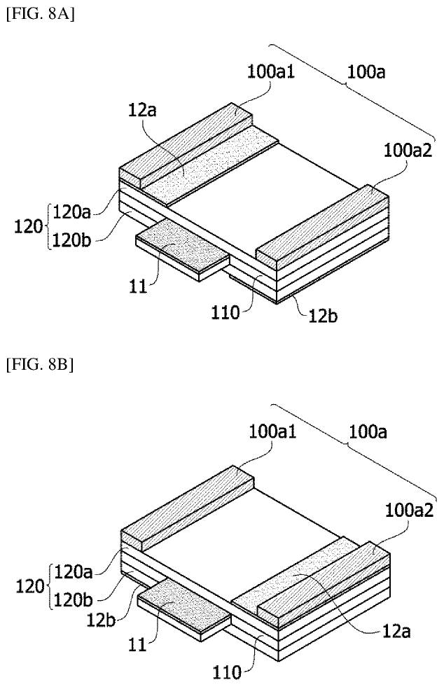

FIGS. 6A and 6B are views illustrating a third structure of a vibrating body on which weights illustrated in FIG. 2 are disposed.

Referring to FIGS. 6A and 6B, weights 100a-2b according to an embodiment may include a first weight 100a1-2 and a second weight 100a2-2, and the first weight 100a1-2 and the second weight 100a2-2 may be disposed on two side surfaces of a vibrating body 100.

For example, the first weight 100a1-2 may be disposed on and coupled to one side surface of the vibrating body 100 including an elastic body 110 and piezoelectric elements 120, and the second weight 100a2-2 may be disposed on and coupled to the other side surface of the vibrating body 100 including the elastic body 110 and the piezoelectric elements 120.

A size of a bonding surface of the first weight 100a1-2 and a size of the one side surface of the vibrating body 100 are the same, and a size of a bonding surface of the second weight 100a2-2 and a size of the other side surface of the vibrating body 100 are the same.

The first weight 100a1-2 and the second weight 100a2-2 may have the same size and weight.

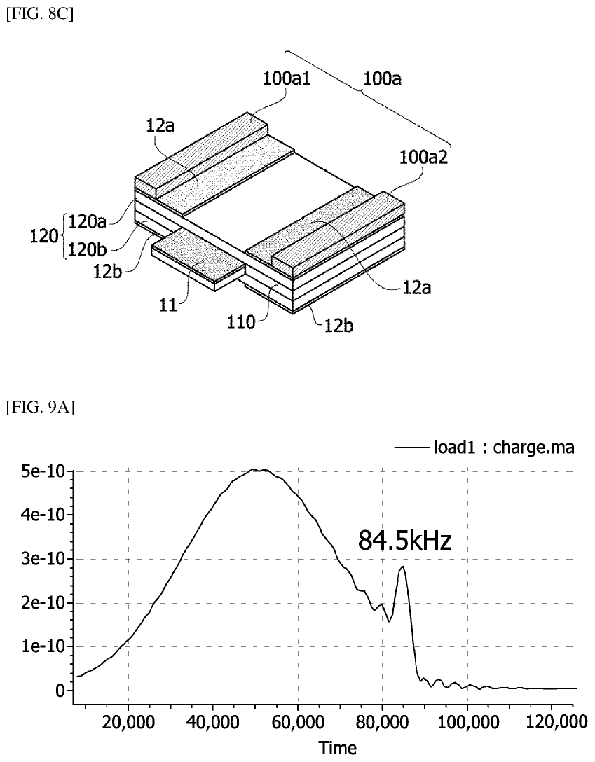

FIGS. 7A and 7B are views illustrating a fourth structure of a vibrating body on which weights illustrated in FIG. 2 are disposed.

Referring to FIGS. 7A and 7B, weights 100a-3 according to an embodiment may include a plurality of first weights 100a1-3 and a plurality of second weights 100a2-3, and the plurality of first weights 100a1-3 and the plurality of second weights 100a2-3 may be disposed on two side surfaces of a vibrating body 100.

The first weights 100a1-3 and the second weights 100a2-3 may have the same size and weight.

The first weights 100a1-3 may include an eleventh weight 100a11-3 and a twelfth weight 100a12-3, the eleventh weights 100a11-3 and the twelfth weight 100a12-3 may be disposed on two side surfaces of a first piezoelectric element 120a, the second weights 100a2-3 may include a twenty first weight 100a21-3 and a twenty second weight 100a22-3, and the twenty first weight 100a21-3 and the twenty second weight 100a22-3 may be disposed on two side surfaces of a second piezoelectric element 120b.

A length of an elastic body 110 is greater than a length of each of the piezoelectric elements 120a and 120b and is the same as a total length of the piezoelectric element 120a and the eleventh and twelfth weights 100a11-3 and 100a12-3 which are disposed on the two side surfaces of the piezoelectric element 120a.

A length of each of the eleventh weight 100a11-3 and the twelfth weight 100a12-3 may be designed to be ⅕ or less of the length of the piezoelectric element 120a and may be less than 1 mm. A width of each of the eleventh weight 100a11-3 and the twelfth weight 100a12-3 is the same as a width of the piezoelectric element 120a. A thickness of each of the eleventh weight 100a11-3 and the twelfth weight 100a12-3 may be 1 mm or less.

The length of the elastic body 110 is greater than the length of each of the piezoelectric elements 120a and 120b and is the same as a total length of the piezoelectric element 120b and the twenty first and twenty second weights 100a21-3 and 100a22-3 which are disposed on the two side surfaces of the piezoelectric element 120b.

A length of each of the twenty first weight 100a21-3 and the twenty second weight 100a22-3 may be designed to be ⅕ or less of a length of the piezoelectric element 120b and may be less than 1 mm. A width of each of the twenty first weight 100a21-3 and the twenty second weight 100a22-3 is the same as a width of the piezoelectric element 120b. A thickness of each of the twenty first weight 100a21-3 and the twenty second weight 100a22-3 may be 1 mm or less.

The number, shapes, and arrangement positions of the weights described with reference to FIGS. 4A to 7B are only examples, and the number, shapes, and arrangement positions of the weights are not necessarily limited thereto and may be variously changed according to design purposes.

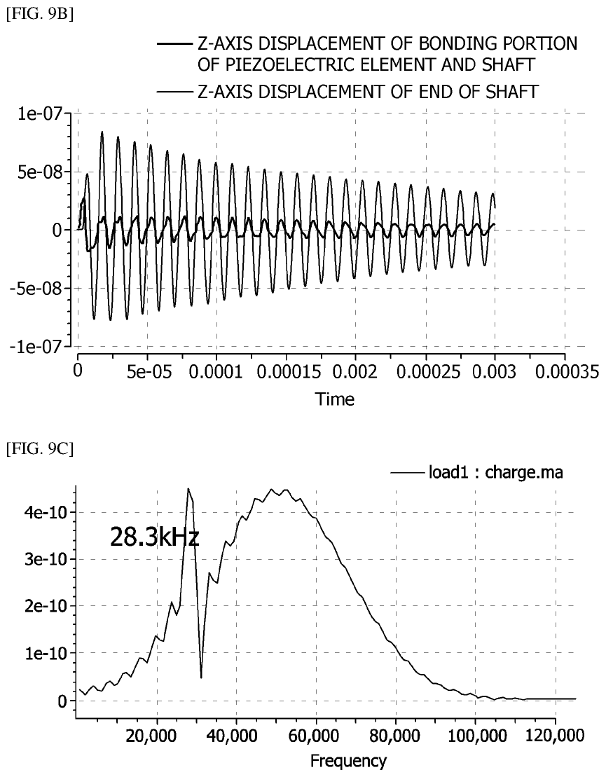

FIGS. 8A to 8C and views for describing forms in which connection members are disposed on a vibrating body.

Referring to FIG. 8A, electric signals may be applied to an elastic body 110, a first piezoelectric element 120a, and a second piezoelectric element 120b, which form a vibrating body 100, through connection members according to an embodiment. The connection members may include a first connection member 11, a second connection member 12a, and a third connection member 12b.

The first connection member 11 may be disposed on the conductive elastic body 110, the second connection member 12a may be disposed between the first piezoelectric element 120a and a first weight 110a1 and connected to an electrode formed on the first piezoelectric element 120a, and the third connection member 12b may be disposed on a lower portion of the second piezoelectric element 120b and connected to an electrode formed on the second piezoelectric element 120b.

The first connection member 11, the second connection member 12a, and the third connection member 12b may be attached and coupled using an adhesive member. In this case, the adhesive member does not necessarily have to be a conductive material and may be formed to have a thickness of 3 to 10 μm.

The first connection member 11 may be disposed on a central portion of one side of the elastic body 110 to protrude from the one side of the elastic body 110.

The third connection member 12b may be disposed on the lower portion of the second piezoelectric element 120b corresponding to a second weight 110a2. Accordingly, the second connection member 12a and the third connection member 12b may be disposed one side and the other side of the first connection member 11 based on the first connection member 11.

Separation distances of the second connection member 12a and the third connection member 12b from the first connection member 11 are the same, sizes and weights of the second connection member 12a and the third connection member 12b may be the same.

A flexible printed circuit board (FPCB) may be used as the connection member.

Referring to FIG. 8B, a first connection member 11 according to an embodiment may be disposed on an elastic body 110, a second connection member 12a may be disposed between a first piezoelectric element 120a and a second weight 110a2, and a third connection member 12b may be disposed on a lower portion of a second piezoelectric element 120b.

The first connection member 11 may be disposed on a central portion of one side of the elastic body 110 to protrude from the one side of the elastic body 110.

The third connection member 12b may be disposed on the lower portion of the second piezoelectric element 120b corresponding to a first weight 110a1. Accordingly, the second connection member 12a and the third connection member 12b may be disposed at one side and the other side of the first connection member 11 based on the first connection member 11.

Referring to FIG. 8C, a first connection member 11 according to an embodiment may be disposed on an elastic body 110, second connection members 12a may be disposed between a first piezoelectric element 120a and a first weight 110a1 and between the first piezoelectric element 120a and a second weight 110a2, third connection members 12b may be despised on one lower end portion and the other lower end portion of a second piezoelectric element 120b.

The first connection member 11 may be disposed on a central portion of one side of the elastic body 110 to protrude from the one side of the elastic body 110.

The third connection members 12b may be disposed on the one lower end portion of the second piezoelectric element 120b corresponding to the first weight 110a1 and the other lower end portion of the second piezoelectric element 120b corresponding to the second weight 110a2. Accordingly, the second connection members 12a and the third connection members 12b may be disposed at one side and the other side of the first connection member 11 based on the first connection member 11. That is, the connection members according to the embodiment are disposed in consideration of a center of gravity.

The numbers and the arrangement positions of the connection members described with reference to FIGS. 8A to 8C are only examples, and the numbers and the arrangement positions of the connection members are not necessarily limited thereto and may be variously changed according to design purposes.

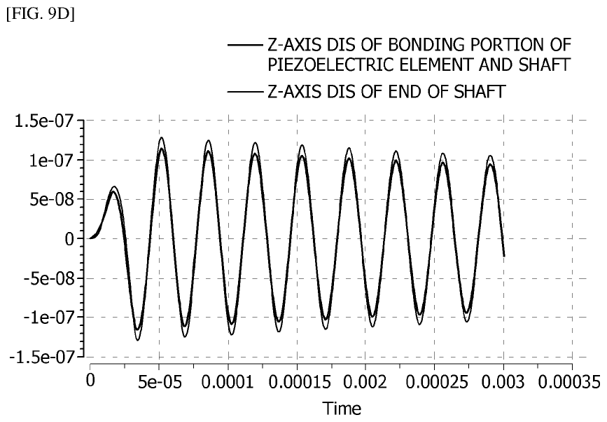

FIGS. 9A to 9D are graphs showing simulation results of an ultrasonic linear motor.

Referring to FIGS. 9A and 9B, it shows a simulation result of a resonance frequency or driving frequency and z-axis displacements at a connection portion of a piezoelectric element and a moving shaft and an end portion of the moving shaft when an ultrasonic linear motor of the conventional technology is used and the moving shaft formed of a stainless material is used.

As illustrated in FIG. 9A, it shows that a driving frequency is 84.5 kHz.

As illustrated in FIG. 9B, it shows that a z-axis displacement of the connection portion and a z-axis displacement of the end portion sharply decrease depending on time, and the z-axis displacement of the connection portion is significantly small compared to the z-axis displacement of the end portion.

Referring to FIGS. 9C and 9D, it shows a simulation result of a driving frequency and z-axis displacements of a connection portion of a piezoelectric element and a moving shaft and an end portion of the moving shaft when an ultrasonic linear motor according to an embodiment is used and the moving shaft formed of a stainless material is used.

As illustrated in FIG. 9C, it shows that a driving frequency is 28.3 kHz which is shifted to a frequency in a low band when compared to the motor of the conventional technology. Since the driving frequency and a magnitude of a driving voltage are proportional, when the driving frequency is shifted in the low band, power consumption can be decreased.

As illustrated in FIG. 9, it shows that the z-axis displacement of the connection portion and the z-axis displacement of the end portion decrease gradually depending on time, and the z-axis displacement of the connection portion and the z-axis displacement of the end portion are substantially the same.

Since such a stainless material is heavy, although a decrease in displacement and a change in resonance may occur, the decrease in the displacement due to an increase in weight and the change in the resonance of an elastic body can be minimized.

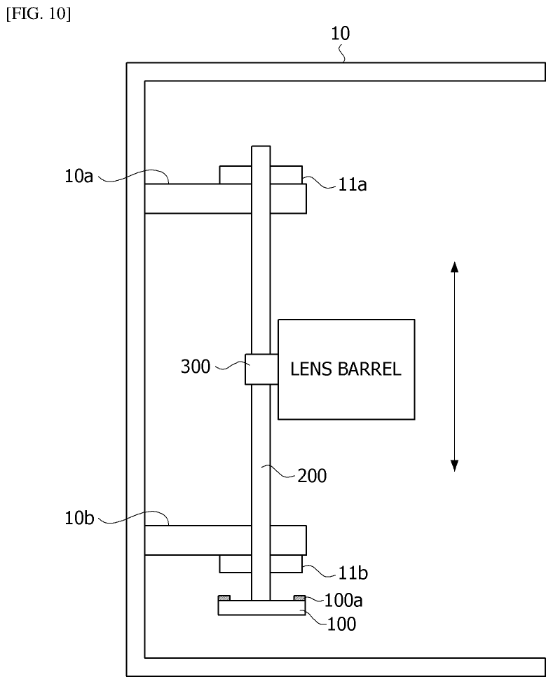

FIG. 10 is a view for describing an installation state of an ultrasonic linear motor according to an embodiment.

Referring to FIG. 10, the ultrasonic linear motor according to the embodiment may be used to adjust a zoom of, for example, a digital single lens reflex (DSLR) camera, a moving shaft may be inserted into support members 10a and 10b formed on a housing 10 and fixed using fixing members 11a and 11b.

For example, rubber rings or resins may be used as the fixing members 11a and 11b.

While the present invention has been described above with reference to the exemplary embodiments of the present invention, it may be understood by those skilled in the art that various modifications and changes of the present invention may be made within a range not departing from the spirit and scope of the present invention defined by the appended claims.

### REFERENCE NUMERALS

100: VIBRATING BODY
110: ELASTIC BODY
120: PIEZOELECTRIC ELEMENT
100A: WEIGHT
200: MOVING SHAFT
300: MOVING BODY

1. An ultrasonic linear motor comprising:
a vibrating body including an elastic body and a first piezoelectric element and a second piezoelectric element which are attached to two surfaces of the elastic body;
a first weight and a second weight which are disposed on two side end portions of the vibrating body;
a moving shaft which is coupled to a central portion of the vibrating body and moves according to a displacement of each of the piezoelectric elements; and
a moving body which is fitted to the moving shaft and moves on the moving shaft.

2. The ultrasonic linear motor of claim 1, wherein:
the first weight is disposed on one upper end portion of the first piezoelectric element; and
the second weight is disposed on the other upper end portion of the first piezoelectric element.

3. The ultrasonic linear motor of claim 1, wherein:
the first weight is disposed on one lower end portion of the second piezoelectric element; and
the second weight is disposed on the other lower end portion of the second piezoelectric element.

4. The ultrasonic linear motor of claim 1, wherein:
the first weight is disposed on one side surface portion of the vibrating body; and
the second weight is disposed on the other side surface portion the vibrating body.

5. The ultrasonic linear motor of claim 1, wherein:
the first weight is disposed on each of two side surface portions of the first piezoelectric element; and
the second weight is disposed on each of two side surface portions of the second piezoelectric element.

6. The ultrasonic linear motor of claim 5, wherein:
the first piezoelectric element and the first weight are disposed on one surface of the elastic body; and
the second piezoelectric element and the second weight are disposed on the other surface of the elastic body.

7. The ultrasonic linear motor of claim 1, further comprising connection members through which electric signals are applied to the elastic body, the first piezoelectric element, and the second piezoelectric element,
wherein the connection members include:
a first connection member connected to one side of the elastic body;
a second connection member connected to one side of the first piezoelectric element; and
a third connection member connected to one side of the second piezoelectric element.

8. The ultrasonic linear motor of claim 7, wherein the second connection member is disposed between the first weight and the first piezoelectric element or disposed between the second weight and the first piezoelectric element.

9. The ultrasonic linear motor of claim 8, wherein the third connection member is disposed on a lower portion of the second piezoelectric element corresponding to the second weight or disposed on a lower portion of the first piezoelectric element corresponding to the first weight.

10. The ultrasonic linear motor of claim 1, wherein:
a length of each of the first piezoelectric element and the second piezoelectric element is two or more times a width thereof; and
a thickness of each of the first piezoelectric element and the second piezoelectric element is 1/10 or less of the length.

11. The ultrasonic linear motor of claim 1, wherein a length of the weight is ⅕ or less of a length of the first piezoelectric element or the second piezoelectric element.

12. The ultrasonic linear motor of claim 1, wherein a thickness of the weight is less than 1 mm.

13. The ultrasonic linear motor of claim 1, wherein a material of the weight is stainless.

14. The ultrasonic linear motor of claim 1, wherein a thickness of the elastic body is 1 to 1.5 times a thickness of the first piezoelectric element or the second piezoelectric element.

15. The ultrasonic linear motor of claim 1, wherein a length of the moving shaft is 2.5 to 3.5 times a length of the elastic body.

16. An ultrasonic linear motor comprising:
a vibrating body including an elastic body and piezoelectric elements;
a first weight disposed on one side end portion of the vibrating body; and
a second weight disposed on the other side end portion of the vibrating body,
wherein sizes and weights of the first weight and the second weight are the same.

17. The ultrasonic linear motor of claim 16, wherein:
the first weight is disposed on one upper end portion of the piezoelectric element; and
the second weight is disposed on the other upper end portion of the piezoelectric element.

18. The ultrasonic linear motor of claim 16, wherein:
the first weight is disposed on one lower end portion of the piezoelectric element; and
the second weight is disposed on the other lower end portion of the piezoelectric element.

19. The ultrasonic linear motor of claim 16, wherein:
the first weight is disposed on one side surface portion of the vibrating body; and
the second weight is disposed on the other side surface portion of the vibrating body.

20. The ultrasonic linear motor of claim 16, wherein:
the first weight is disposed on each of two side surface portions of the first piezoelectric element; and
the second weight is disposed on each of two side surface portions of the second piezoelectric element.
